(19) United States
(12) Patent Application Publication
(10) Pub. No.: US 2023/0224656 A1
(43) Pub. Date: Jul. 13, 2023

(54) METHOD OF TRAINING NEURAL NETWORK MODEL, METHOD OF RECOGNIZING ACOUSTIC EVENT AND ACOUSTIC DIRECTION, AND ELECTRONIC DEVICE FOR PERFORMING THE METHODS

(71) Applicant: Electronics and Telecommunications Research Institute, Daejeon (KR)

(72) Inventors: Soo Young PARK, Daejeon (KR); Tae Jin LEE, Daejeon (KR); Young Ho JEONG, Daejeon (KR)

(73) Assignee: Electronics and Telecommunications Research Institute, Daejeon (KR)

(21) Appl. No.: 17/869,171

(22) Filed: Jul. 20, 2022

(30) Foreign Application Priority Data
Jan. 7, 2022 (KR) 10-2022-0002603

(51) Int. Cl. H04R 29/00; G06N 3/08

(52) U.S. Cl. CPC H04R 29/008; G06N 3/08

(57) ABSTRACT

Provided are a method of training a neural network model, a method of recognizing an acoustic event and an acoustic direction, and an electronic device for performing the methods. A method of training a neural network model according to an example embodiment includes generating a heatmap indicating an acoustic event and an acoustic direction in which the acoustic event occurs by using training data, outputting a result of recognizing the acoustic event and the acoustic direction by inputting a feature extracted using the training data into a neural network model for recognizing the acoustic event and the acoustic direction of the training data, and training the neural network model by using the result and the heatmap.

### CROSS-REFERENCE TO RELATED APPLICATION

This application claims priority to Korean Patent Application No. 10-2022-0002603 filed on Jan. 7, 2022, in the Korean Intellectual Property Office, the entire disclosure of which is incorporated herein by reference for all purposes.

### BACKGROUND

### 1. Field of the Invention

One or more example embodiments relate to a method of training a neural network model, a method of recognizing an acoustic event, and an electronic device for performing the methods.

### 2. Description of the Related Art

Acoustic event recognition and direction detection are issues of classifying which acoustic event the generated sound is and inferring from which direction the sound comes. As a general method of classifying the acoustic event and inferring the direction of the acoustic event, a method is being used divided into two approaches: acoustic event recognition through multi-label classification and acoustic event direction detection network through multi-output regression.

The method is to detect an occurrence event in the multi-label classification and find the direction of the acoustic event by matching with an acoustic event direction detection result through the multi-output regression.

### SUMMARY

In the case of detecting the occurrence event in the multi-label classification and matching the direction of the acoustic event with the acoustic event direction detection result through the multi-output regression, and in the case that an acoustic event of the same class occurs duplicately, it is difficult to detect the directions of the acoustic events occurring simultaneously.

Example embodiments provide a method of training a neural network model, a method of recognizing an acoustic event and an acoustic direction, and an electronic device for performing the methods, capable of, when an acoustic event of the same class occurs duplicately in an acoustic event and acoustic direction recognition system using the neural network model, recognizing directions of the duplicately occurring acoustic events.

Example embodiments provide a method of training a neural network model, a method of recognizing an acoustic event and an acoustic direction, and an electronic device for performing the methods, capable of, when an acoustic event of the same class occur duplicately, recognizing directions of the duplicately occurring acoustic events through heatmap regression.

According to an aspect, there is provided a method of training a neural network model including generating a heatmap indicating an acoustic event and an acoustic direction in which the acoustic event occurs by using training data, outputting a result of recognizing the acoustic event and the acoustic direction by inputting a feature extracted using the training data into a neural network model for recognizing the acoustic event and the acoustic direction of the training data, and training the neural network model by using the result and the heatmap.

The generating of the heatmap may include generating the heatmap including a time at which the acoustic event occurs, a vertical direction and a horizontal direction indicating the acoustic direction, and a class indicating the acoustic event.

The heatmap may indicate a probability of occurrence of the acoustic event corresponding to the class in the vertical direction and the horizontal direction at the time.

The generating of the heatmap may include generating the heatmap by using the training data for the same acoustic event occurring at the same time in a plurality of the acoustic directions, and the training of the neural network model may include training the neural network model to recognize the plurality of acoustic directions.

According to another aspect, there is provided a method of recognizing an acoustic event and an acoustic direction includes identifying acoustic data including an acoustic event and an acoustic direction in which the acoustic event occurs, and outputting a result of recognizing the acoustic event and the acoustic direction by inputting a feature extracted using the acoustic data into a neural network model trained to recognize the acoustic event and the acoustic direction.

The outputting of the result may include outputting a heatmap including a time at which the acoustic event occurs, a vertical direction and a horizontal direction indicating the acoustic direction, and a class indicating the acoustic event.

The heatmap may indicate a probability of occurrence of the acoustic event in the vertical direction and the horizontal direction corresponding to the class at the time.

The identifying of the acoustic data may include identifying the acoustic data for the same acoustic event occurring at the same time in a plurality of the acoustic directions, and the outputting of the result may include recognizing the plurality of acoustic directions and outputting a result thereof.

According to another aspect, there is provided an electronic device includes a processor, and the processor is configured to identify acoustic data including an acoustic event and an acoustic direction in which the acoustic event occurs, and output a result of recognizing the acoustic event and the acoustic direction by inputting a feature extracted using the acoustic data into a neural network model trained to recognize the acoustic event and the acoustic direction.

The processor may be configured to output a heatmap including a time at which the acoustic event occurs, a vertical direction and a horizontal direction indicating the acoustic direction, and a class indicating the acoustic event.

The heatmap may indicate a probability of occurrence of the acoustic event in the vertical direction and the horizontal direction corresponding to the class at the time.

The processor may be configured to identify the acoustic data for the same acoustic event occurring at the same time in a plurality of the acoustic directions, and output a result of recognizing the plurality of acoustic directions.

Additional aspects of example embodiments will be set forth in part in the description which follows and, in part, will be apparent from the description, or may be learned by practice of the disclosure.

According to example embodiments, when acoustic events of the same class occur duplicately, it is possible to recognize a plurality of directions of the duplicately occurring acoustic events.

According to example embodiments, when the acoustic events of the same class occur duplicately, it is possible to improve recognition performance of an acoustic event and acoustic direction recognition model by recognizing a plurality of directions of the duplicately occurring acoustic events through the heatmap regression.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an operation of training a neural network model of an electronic device according to an example embodiment;

FIG. 2 is a flowchart illustrating an operation of training a neural network model of an electronic device according to an example embodiment;

FIG. 3 is a diagram illustrating an operation of recognizing an acoustic event and an acoustic direction by an electronic device using a neural network model according to an example embodiment;

FIG. 4 and FIG. 5 are flowcharts of operations of recognizing an acoustic event and an acoustic direction by an electronic device using a neural network model according to an example embodiment; and

FIG. 6 is a diagram illustrating a heatmap when acoustic events of the same class occur in a plurality of acoustic directions according to an example embodiment.

### DETAILED DESCRIPTION

Hereinafter, example embodiments will be described in detail with reference to the accompanying drawings Various modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

When describing the example embodiments with reference to the accompanying drawings, like reference numerals refer to like components and a repeated description related thereto will be omitted. When it is determined that specific descriptions of a well-known technology relating to the example embodiments may unnecessarily obscure the gist of the present disclosure, detailed descriptions thereof are omitted.

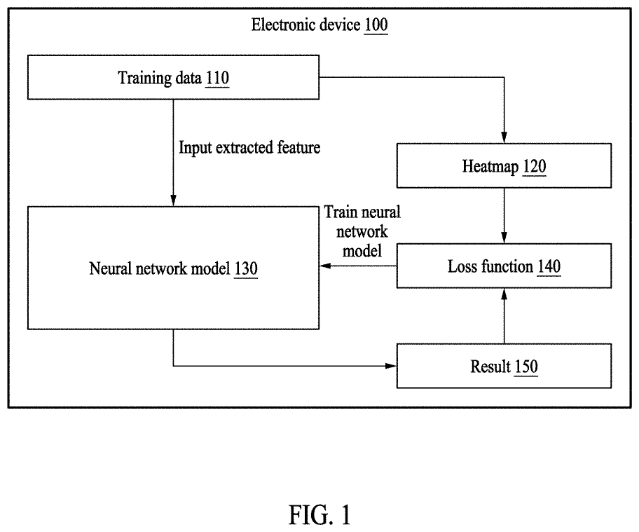

FIG. 1 is a diagram illustrating an operation of training a neural network model 130 of an electronic device 100 according to an example embodiment.

Referring to FIG. 1, the electronic device 100 may identify training data 110 stored in a storage device (e.g., a memory) or input from the outside. For example, the electronic device 100 may include a memory. The electronic device 100 according to an example embodiment may include a processor (not shown). The electronic device 100 may perform operations for training the neural network model 130 using the processor.

Referring to FIG. 1, the electronic device 100 according to various example embodiments may generate a heatmap 120 representing an acoustic event and a direction in which the acoustic event will occur by using training data 110. For example, the processor of the electronic device 100 may store the generated heatmap 120 in the memory.

For example, the electronic device 100 may generate the heatmap 120 for each acoustic event or time period using the training data 110. For example, the heatmap 120 may refer to an image in which various information that may be expressed in colors or the like is output as a graphic in the form of heat distribution on the image. For example, the electronic device 100 may generate the heatmap 120 for each acoustic class.

For example, the training data 110 may include acoustic data 310, and the electronic device 100 may generate the heatmap 120 using the training data 110 for each acoustic event and for each time period. The generated heatmap 120 may indicate whether the acoustic event has occurred in a corresponding acoustic event and time period, and may indicate an acoustic direction that is a direction of the acoustic event which has occurred.

As an example, the heatmap 120 may include a class, time, a vertical direction, or a horizontal direction. For example, the heatmap 120 may be generated in a four-dimensional structure such as (time x vertical direction x horizontal direction x class).

For example, the time of the heatmap 120 may indicate a time when the acoustic event occurs, and the vertical direction and horizontal directions may indicate the acoustic direction. For example, a class may refer to a type of the acoustic event.

For example, the electronic device 100 may generate the heatmap 120 representing a probability of occurrence of the acoustic event. For example, the electronic device 100 may generate the heatmap 120 representing the probability of occurrence of the acoustic event corresponding to the class of the heatmap 120 in the horizontal direction and the vertical direction during the corresponding time period. For example, the electronic device 100 may generate the heatmap 120 in which the vertical direction and the horizontal direction with a high probability of occurrence of the acoustic event are displayed.

As an example, the electronic device 100 may generate the Gaussian heatmap 120 representing a location where the acoustic event corresponding to a specific class occurs for each time period.

For example, the electronic device 100 may identify the time, the vertical direction, the horizontal direction, and the class according to the acoustic event included in the training data 110. For example, the electronic device 100 may determine values corresponding to the identified time, vertical direction, horizontal direction, and class as 1, respectively, and determine the values of the remaining time, vertical direction, horizontal direction, and class as 0. The electronic device 100 may generate the heatmap 120 by multiplying (time×vertical direction×horizontal direction×class) determined as 1 by a two-dimensional (2D) Gaussian distribution.

As an example, the electronic device may determine a variance of the Gaussian distribution and generate the heatmap 120. For example, the electronic device 100 may generate the heatmap 120 having a wide ground truth area by multiplying a Gaussian distribution with a large variance by the identified time, vertical, horizontal, and class. For example, the electronic device 100 may generate the heatmap 120 having a narrow ground truth area by multiplying a Gaussian distribution with a small variance by the identified time, vertical direction, horizontal direction, and class.

The electronic device 100 according to various example embodiments may extract a feature from the training data 110. For example, the electronic device 100 may include the neural network model 130. The electronic device 100 may input the extracted feature to the neural network model 130 and output a result 150 of recognizing the acoustic event and the acoustic direction. For example, the feature extracted from the training data 110 may refer to input data for training the neural network model 130, and the heatmap 120 may refer to a ground truth for training the neural network model 130. For example, the heatmap 120 may refer to target data. The feature extracted from the training data 110 may be extracted differently according to the type, a configuration of the neural network model 130 and the like.

For example, the neural network model 130 may recognize the acoustic event and the acoustic direction by using the input feature. For example, the neural network model 130 may recognize whether the acoustic event is included in the training data 110 by using the feature extracted from the training data 110, and may recognize the acoustic direction which is the location where the acoustic event occurs corresponding to occurrence time of the recognized acoustic event and the class of the recognized acoustic event. The neural network model 130 may output the recognized acoustic event and the acoustic direction as the result 150.

For example, the neural network model 130 may output the heatmap 120 by using the feature of the input training data. For example, the heatmap 120 output from the neural network model 130 may include the class, time, vertical direction or horizontal direction such as the heatmap 120 generated from the training data 110, and the heatmap 120 may be generated in a four-dimensional structure such as (time x vertical direction x horizontal direction x class).

For example, the result 150 output from the neural network model 130 has the same configuration as the heatmap 120, and has a predicted value calculated through the neural network model 130. The heatmap 120 generated by the electronic device 100 from the training data 110 may be generated using the acoustic event and the acoustic direction known to the training data 110.

For example, the neural network model 130 may output the acoustic event and the acoustic direction in the form of the heatmap 120. The result 150 output from the neural network model 130 may have the same configuration as the heatmap 120. The electronic rule 100 may calculate a loss function 140 by using the result 150 output from the neural network model 130 and the heatmap 120 generated from the training data 110.

As an example, various well-known neural network models 130 may be applied to the neural network model 130. For example, the neural network model 130 may include a plurality of artificial neural network layers. The artificial neural network may include at lest one of a deep neural network (DNN), a convolutional neural network (CNN), a recurrent neural network (RNN), a restricted boltzmann machine (RBM), a deep belief network (DBN), a bidirectional recurrent deep neural network (BRDNN), or a deep Q-network, but the artificial neural network is not limited to the above-described examples. In addition to the hardware structure, the neural network model 130 may additionally or alternatively include a software structure.

The electronic device 100 according to various example embodiments may train the neural network model 130 by using the generated heatmap 120 and the result 150 output from the neural network model 130. For example, the electronic device 100 may obtain the loss function 140 using the heatmap 120 output from the neural network model 130 and the heatmap 120 generated from the training data 110, and may train the neural network model 130 to minimize the loss function 140.

For example, the electronic device 100 may train the neural network model 130 by performing regression of the heatmap 120. For example, the electronic device 100 may obtain the loss function 140 by using the pixel-by-pixel difference between the heatmap 120 output from the neural network model 130 and the heatmap 120 generated from the training data 110, the difference of the determined key point and the like. The electronic device 100 may perform the regression of the heatmap 120 using a known art regarding the regression of heatmap 120 and train the neural network model 130.

For example, in the case that acoustic events of the same class occur in a plurality of acoustic directions simultaneously, the electronic device 100 may train the neural network model 130 to recognize the plurality of acoustic directions. The electronic device 100 may use the heatmap 120 generated from the training data 110 as ground truth for training the neural network model 130. The electronic device 100 may train the neural network model 130 for recognizing the acoustic event and the acoustic direction by using the regression of the heatmap 120, so that the neural network model 130 may be trained to recognize that the acoustic events of the same class occur in the plurality of acoustic directions.

For example, the training data 110 may include data for the same acoustic event occurring at the same time in the plurality of acoustic directions. The electronic device 100 may generate the heatmap 120 by using the training data 110, and the generated heatmap 120 may include the same acoustic event occurring simultaneously in the plurality of acoustic directions. The electronic device 100 may input the feature extracted from the training data 110 to the neural network model 130 to output the result 150, and train the neural network model 130 to recognize a plurality of acoustic directions using the result 150 and the heatmap 120.

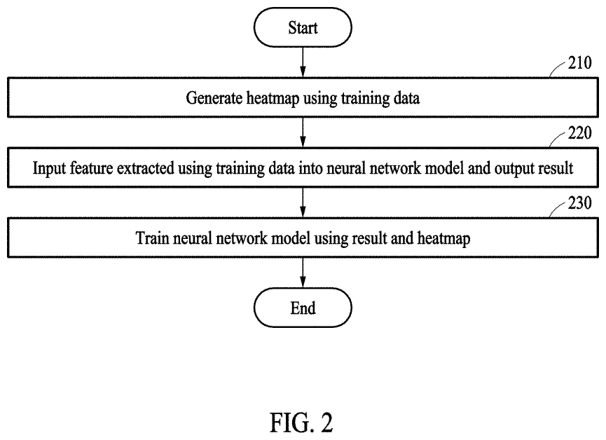

FIG. 2 is a flowchart of an operation of training the neural network model 130 of the electronic device 100 according to an example embodiment.

Referring to FIG. 2, the electronic device 100 according to various example embodiments may generate the heatmap 120 using the training data 110 in operation 210. For example, the training data 110 may include the acoustic data 310. For example, the acoustic data 310 may include the acoustic event and the acoustic direction that is a direction in which the acoustic event occurs. The heatmap 120 generated by the electronic device 100 using the training data 110 may include the class corresponding to the acoustic event, the time the acoustic event occurs, and the vertical direction and the horizontal direction indicating the acoustic direction in which the acoustic event occurs. For example, the heatmap 120 may indicate a probability of occurrence of the acoustic event in the vertical direction and the horizontal direction in the training data 110.

The electronic device 100 according to various example embodiments may extract a feature using the training data 110, and input the extracted feature to the neural network model 130 to output the result 150 in operation 220. The neural network model 130 may be a neural network model 130 that is trained to recognize the acoustic event and the acoustic direction using the input feature. The result 150 output from the neural network model 130 may indicate the class indicating the recognized acoustic event, the time at which the recognized acoustic event occurs, and the acoustic direction in which the recognized acoustic event occurs, for example, the vertical direction and the horizontal direction.

For example, the result 150 output from the neural network model 130 may have substantially the same format as the heatmap 120 generated by the electronic device 100 using the training data 110, for example, the result 150 may include the class, the time, the vertical direction and the horizontal direction.

In operation 230, the electronic device 100 according to various example embodiments may train the neural network model 130 using the result 150 and the heatmap 120. The electronic device 100 may obtain the loss function 140 related to the acoustic event and the acoustic direction by using the result 150 and the heatmap 120. The electronic device 100 may train the neural network model 130 to minimize the loss function 140.

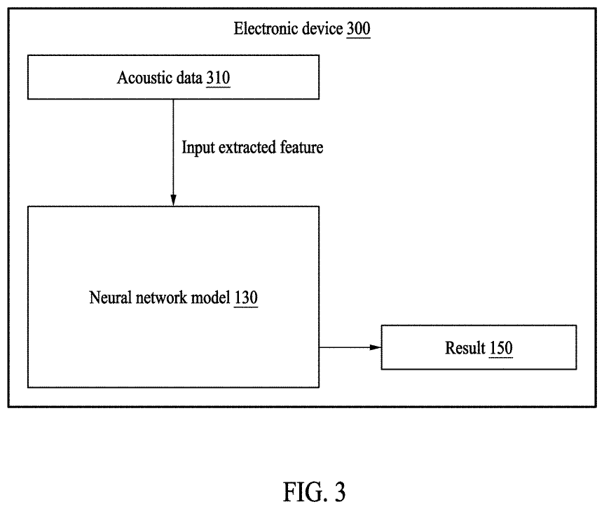

FIG. 3 is a diagram illustrating an operation of recognizing an acoustic event and an acoustic direction by an electronic device 300 using the neural network model 130 according to an example embodiment.

Referring to FIG. 3, the electronic device 300 may input the acoustic data 310 into the neural network model 130 and output the result 150. For example, the result 150 output from the neural network model 130 may indicate the acoustic event and the acoustic direction in which the acoustic event occurs included in the acoustic data 310.

For example, the neural network model 130 shown in FIG. 3 may be the neural network model 130 trained according to the electronic device 100 and the neural network model 130 training method shown in FIG. 1 and FIG. 2. For example, the result 150 output from the neural network model 130 of FIG. 3 may be generated in the same form as a result output from the heatmap 120 and/or the neural network model 130 generated by the electronic device 100 shown in FIG. 1 and FIG. 2, for example, the result 150 may be generated in the time, the class, the vertical direction and the horizontal direction.

For example, the result 150 output from the neural network model 130, for example, the heatmap 120 may indicate the recognized acoustic event, the time when the acoustic event occurs, and a probability of the acoustic direction in which the acoustic event occurs.

For example, the electronic device 300 shown in FIG. 3 may output the result 150 of recognizing a plurality of acoustic directions using the neural network model 130. For example, in the case that the acoustic data 310 is data for the same acoustic event occurring in the plurality of acoustic directions at the same time, it may be recognized from the result 150 output from the neural network model 130 that the same acoustic event occurs in the plurality of acoustic directions at the same time.

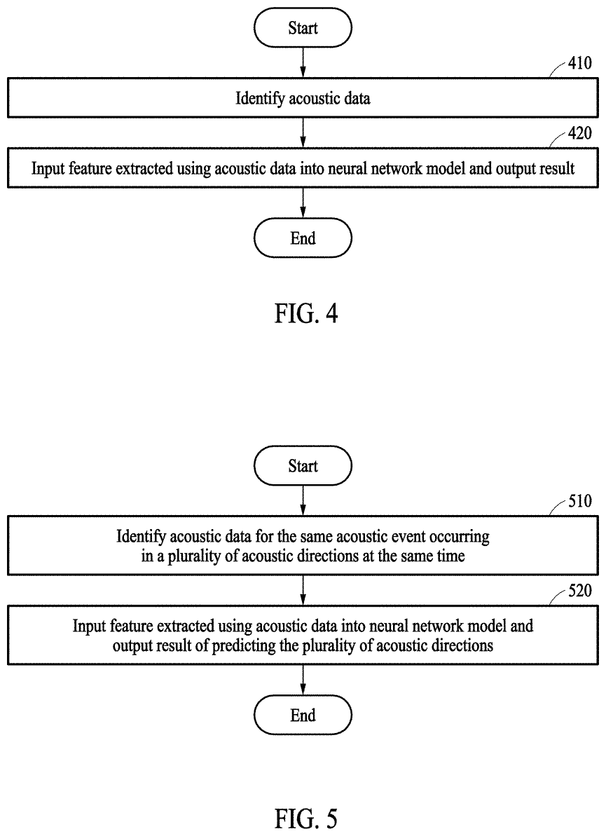

FIG. 4 and FIG. 5 are flowcharts illustrating operations of recognizing an acoustic event and an acoustic direction by the electronic device 300 using the neural network model 130 according to an example embodiment.

Referring to FIG. 4, the electronic device 300 according to an example embodiment may identify the acoustic data 310 in operation 410. The acoustic data 310 may include the acoustic event and the acoustic direction in which the acoustic event occurs.

The electronic device 300 according to an example embodiment may extract a feature using the acoustic data 310 in operation 420. The electronic device 300 may output the result 150 by inputting the feature extracted in operation 420 to the neural network model 130. As an example, the output result 150 may indicate the acoustic event recognized using the feature using the acoustic data 310, the time when the acoustic event occurs, and the acoustic direction in which the acoustic event occurs, for example, the vertical direction and the horizontal direction. For example, the result 150 output from the neural network model 130 may be a heatmap 120 generated to include the time, the class, the vertical direction, and the horizontal direction.

Referring to FIG. 5, the electronic device 300 according to various example embodiments may identify the acoustic data 310 in operation 510. The acoustic data 310 identified by the electronic device 300 in operation 510 may include the same acoustic event occurring in the plurality of acoustic directions at the same time.

In operation 520, the electronic device 300 according to an example embodiment may output the result 150 by inputting the feature extracted using the acoustic data 310 to the neural network model 130. The result 150 output by the neural network model 130 in operation 520 may be recognition or prediction of the plurality of acoustic directions. For example, the result 150 output in operation 520 may indicate that the same acoustic event occurs in the plurality of acoustic directions at the same time.

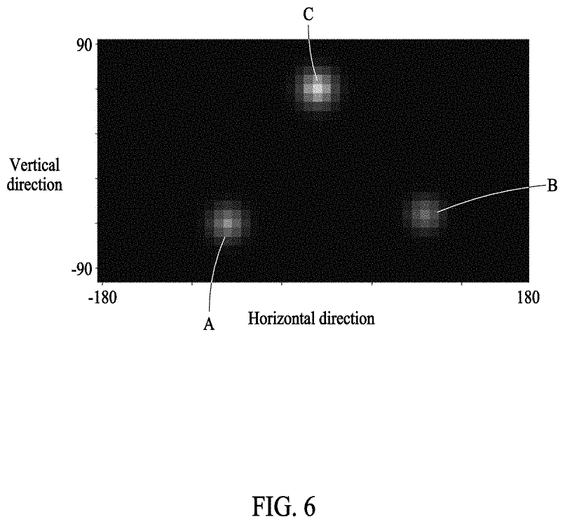

FIG. 6 is a diagram illustrating the heatmap 120 when acoustic events of the same class occur in a plurality of acoustic directions according to an example embodiment.

The heatmap 120 shown in FIG. 6 may be an example of the heatmap 120 generated by the electronic device 100 of FIG. 1 from the training data 110, the result 150 output by inputting the feature extracted from the training data 110 to the neural network model 130 by the electronic device 100 of FIG. 1, and the result 150 output by inputting the feature extracted from the acoustic data 310 to the neural network model 130 by the electronic device 300 of FIG. 3.

The heatmap 120 shown in FIG. 6 is a diagram illustrating the acoustic events of the same class occurring in the plurality of acoustic directions at the same time. It may be identified from FIG. 6 that the same acoustic event occurs in acoustic directions of A, B, and C.

Referring to FIG. 6, the training data 110 and the acoustic data 310 may include the same acoustic event occurring at the same time in the plurality of acoustic directions.

The heatmap 120 of FIG. 6 may be the heatmap 120 generated from the training data 110 or the result 150 output from the neural network model 130. The electronic device 100 of FIG. 1 may generate the heatmap 120 as shown in FIG. 6 indicating the same acoustic event occurring at the same time in the plurality of acoustic directions by using the training data 110. The neural network model 130 trained by the electronic device 100 of FIG. 1 may be trained to output the heatmap 120 as shown in FIG. 6, and to recognize the same acoustic event occurring at the same time in the plurality of acoustic directions.

Referring to FIG. 6, the electronic device 300 of FIG. 3 may output the result 150 of recognizing the same acoustic event occurring at the same time in the plurality of acoustic directions from the acoustic data 310 as the heatmap 120 shown in FIG. 6 by using the neural network model 130.

Referring to FIG. 6, the heatmap 120 may mean a probability of occurrence of the acoustic event in the vertical direction and the horizontal direction at a corresponding time. Referring to the acoustic direction C shown in FIG. 6, it may be identified that brightness decreases as the distance from a central position or pixel in the acoustic direction C increases. For example, the brightness in the heatmap 120 may mean a probability that it is determined that an acoustic event occurs. In the acoustic direction C, the probability that the acoustic event occurs at a position corresponding to the pixel of the center is high, and the probability that the acoustic event occurs is low as the distance from the center increases. Substantially the same description as for the acoustic direction C may also be applied to the acoustic directions A and B.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The methods according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of training a neural network model, the method comprising:
generating a heatmap indicating an acoustic event and an acoustic direction in which the acoustic event occurs by using training data;
outputting a result of recognizing the acoustic event and the acoustic direction by inputting a feature extracted using the training data into a neural network model for recognizing the acoustic event and the acoustic direction of the training data; and
training the neural network model by using the result and the heatmap.

2. The method of claim 1, wherein the generating of the heatmap comprises generating the heatmap including a time at which the acoustic event occurs, a vertical direction and a horizontal direction indicating the acoustic direction, and a class indicating the acoustic event.

3. The method of claim 2, wherein the heatmap indicates a probability of occurrence of the acoustic event corresponding to the class in the vertical direction and the horizontal direction at the time.

4. The method of claim 1, wherein the generating of the heatmap comprises generating the heatmap by using the training data for the same acoustic event occurring at the same time in a plurality of the acoustic directions, and
the training of the neural network model comprises training the neural network model to recognize the plurality of acoustic directions.

5. A method of recognizing an acoustic event and an acoustic direction, the method comprising:
identifying acoustic data including an acoustic event and an acoustic direction in which the acoustic event occurs; and
outputting a result of recognizing the acoustic event and the acoustic direction by inputting a feature extracted using the acoustic data into a neural network model trained to recognize the acoustic event and the acoustic direction.

6. The method of claim 5, wherein the outputting of the result comprise outputting a heatmap including a time at which the acoustic event occurs, a vertical direction and a horizontal direction indicating the acoustic direction, and a class indicating the acoustic event.

7. The method of claim 6, wherein the heatmap indicates a probability of occurrence of the acoustic event in the vertical direction and the horizontal direction corresponding to the class at the time.

8. The method of claim 5, wherein the identifying of the acoustic data comprises identifying the acoustic data for the same acoustic event occurring at the same time in a plurality of the acoustic directions, and
the outputting of the result comprises recognizing the plurality of acoustic directions and outputting a result thereof.

9. An electronic device comprising:
a processor,
wherein the processor is configured to:
identify acoustic data including an acoustic event and an acoustic direction in which the acoustic event occurs, and output a result of recognizing the acoustic event and the acoustic direction by inputting a feature extracted using the acoustic data into a neural network model trained to recognize the acoustic event and the acoustic direction.

10. The electronic device of claim 9, wherein the processor is configured to output a heatmap including a time at which the acoustic event occurs, a vertical direction and a horizontal direction indicating the acoustic direction, and a class indicating the acoustic event.

11. The electronic device of claim 10, wherein the heatmap indicates a probability of occurrence of the acoustic event in the vertical direction and the horizontal direction corresponding to the class at the time.

12. The electronic device of claim 9, wherein the processor is configured to identify the acoustic data for the same acoustic event occurring at the same time in a plurality of the acoustic directions, and output a result of recognizing the plurality of acoustic directions.
